(19) United States
(12) Patent Application Publication
(10) Pub. No.: US 2009/0039741 A1
(43) Pub. Date: Feb. 12, 2009

(54) ELECTRIC MOTOR

(75) Inventor: Hans-Dieter Heining, Bad Neustadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, MUNCHEN (DE)

(21) Appl. No.: 10/599,220

(22) PCT Filed: Feb. 25, 2005
(86) PCT No.: PCT/EP2005/050809

§ 371 Date: Oct. 6, 2008

(30) Foreign Application Priority Data
Mar. 22, 2004 (DE) 10 2004 013 919.9

(51) Int. Cl. H02K 11/00

(52) U.S. Cl. 310/68 D

(57) ABSTRACT

The invention relates to an electric motor with a rotating hollow shaft (1) connected to a rotor (4) of the electric motor, wherein for supplying electric energy to the motor, a converter (11) and a corresponding electronic control circuit (13) are at least partly integrated in a hollow space (2) within the hollow shaft (1), whereby the converter (11) and the control electronic circuit (13) are stationarily mounted. This approach produces an electric motor powered by a converter (11) which requires only limited space.

The invention relates to an electric motor with a rotating hollow shaft which is connected to a rotor of the electric motor.

In modern drive engineering, electric motors are typically supplied with electric energy and controlled with a converter. The converter and the stator of the motor are hereby suitably connected with each other. The converter is implemented either as a DC-link converter, a converter without a DC-link, for example as a matrix converter, or simply as an inverter (DC-AC converter). In the case of an inverter, the respective DC current is generated by a corresponding remote rectifier. In addition to the actual converter components, which are effectively provided by the converter valves, each converter also requires associated trigger electronic circuits. The electronic circuit is in the simplest case implemented as driver stages required for switching the valves on and off. However, the electronic circuit can also include, for example, a protective electronic circuit which protects the converter and/or control circuits that control the converter.

In conventional configurations, the converter and the associated electronic control circuit are mounted separately on the motor in a dedicated housing, or they are attached in close proximity to the motor. This layout disadvantageously requires a relatively large installation space. Modern applications, in particular in the field of automation engineering, demand increasingly higher integration densities of the components for designing machines that require the least amount of space.

U.S. Pat. No. 5,424,593 discloses a generator with a drive shaft implemented as a hollow shaft, with a rectifier which rotates with the hollow shaft arranged inside the hollow shaft. The rectifier is used to control the excitation of the generator.

The European Patent 0 194 433 B1 discloses an electric motor with a converter which is arranged, unlike the present invention, as a ring in surrounding disposition of the shaft and surrounded by a bell-shaped rotor hub. This construction is only suitable for large motors which allow enough space between the shaft and the rotor hub.

It is an object of the present invention to provide an electric motor powered by a converter, which requires a small installation space.

The object is solved with an electric motor having a rotating hollow shaft which is connected with the rotor of the electric motor, wherein for providing electric energy to the motor, a converter and an associated electronic control circuit are at least partially integrated in a hollow space inside the hollow shaft, wherein the converter and the electronic control circuit are mounted stationarily.

In a first advantageous embodiment of the invention, the converter and the associated electronic control circuit are completely integrated in the hollow space inside the hollow shaft. This represents a particularly space-saving configuration of the electric motor, including the converter and the electronic control circuit.

Advantageously, the converter is secured on a bearing shield of the motor. Mounting the converter of the bearing shield of the motor can be particularly easily accomplished.

Advantageously, a transducer/encoder can be integrated in the hollow space inside the hollow shaft. Also integrating a transducer in the hollow space obviates the need for mounting the transducer on the outside of the shaft, thereby further reducing the space requirements. The transducer can be employed for commutation, current control, rotation speed control, position control, positioning, monitoring or for visualization purposes.

Advantageously, at least one signal track of the transducer can be arranged on the inside of the hollow shaft. The hollow shaft also supports the signal tracks of the transducer against mechanical stress exerted by the centrifugal forces. The larger diameter of the hollow shaft is also able to accommodate on the inside of the hollow shaft a greater number of signal-producing increments forming the signal track, thereby further increasing the transducer resolution.

In another advantageous embodiment of the invention, the transducer is implemented in form of a magnetic, inductive, optical or capacitive transducer. Magnetic, inductive, optical or capacitive transducers are commonly used in engineering applications.

Advantageously, the electronic evaluation circuit of the transducer can be partially or completely integrated in the hollow space inside the hollow shaft. This further reduces the space requirements.

Advantageously, fan blades can be attached to the inside of the hollow shaft of the motor. Mounting fan blades on the inside of the hollow shaft improves cooling of the converter, of the electronic control circuit and of the electronic evaluation circuit.

Advantageously, the converter can be a converter without DC-link capacitor, in particular a matrix converter. Matrix converters, unlike conventional converters, do not have a temperature-sensitive DC-link capacitor.

Advantageously, a machine-tool production machines can advantageously be driven with the electric motor of the invention, since in the technical field of machine tools or production machines, only limited space is available for the drive systems. However, those skilled in the art will appreciate that the electric motor of the invention can also be employed in other technical areas.

In the context of the present invention, machine tools include single-axis or multi-axes lathes, milling machines, drilling machines or grinding machines. Machine tools in the context of the present invention also include processing centers, linear and rotary transfer machines, laser machines or rolling and gear-making machines. All these machines have in common, that a material is machined, optionally along multiple axes. Production machines in the context of the present invention also include, for example, textile, plastics, wood, glass, ceramics or rock processing machines. Production machines also include machines for forming and packaging, printing or conveying, as well as pumps, fans, lifting gear and robots. In the context of the present invention, production and assembly lines are also included under production machines.

An exemplary embodiment of the invention is depicted in the drawing and will be described in detail hereinafter.

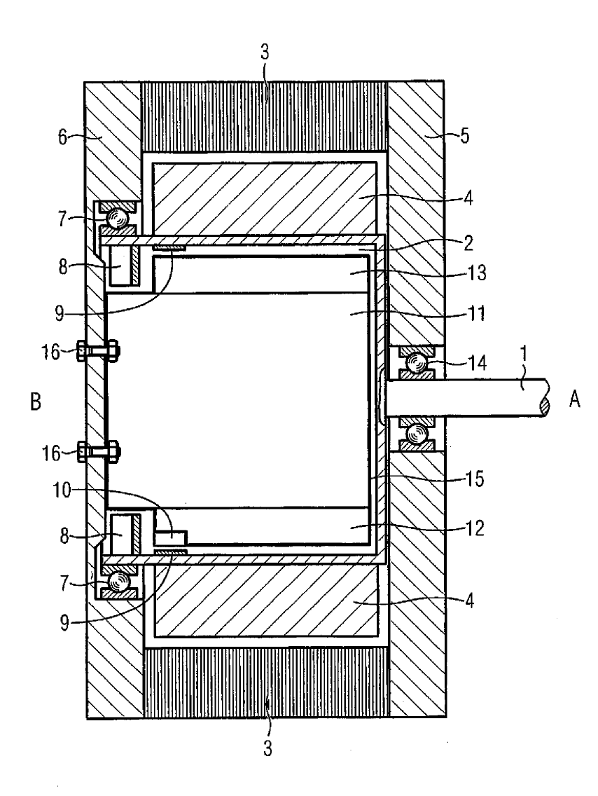

FIG. 1 shows a cross-sectional view of an electric motor according to the invention.

FIG. 1 shows in cross-section an exemplary embodiment of an electric motor according to the invention, wherein the right side of the electric motor in FIG. 1 is designated with the letter “A” and the left side of the motor is designated with the letter “B”. The electric motor essentially includes a hollow shaft 1, which is fixedly connected with a rotor 4, a stator 3 which in the present exemplary embodiment is also a component of the motor housing, and a converter 11 which includes an electronic control circuit 13. Alternatively, the stator 3 can also be mounted in an additional housing. According to the invention, the converter 11 and the electronic control circuit 13 for controlling the converter 11 are integrated in the hollow shaft 1 of the electric motor, wherein unlike in the embodiment depicted in FIG. 1, the converter 11 and the electronic control circuit 13 need not necessarily be completely integrated in the hollow space 2 inside the hollow shaft 1, but portions of the electronic control circuit 13 and/or the converter 11 may also protrude from the B-side section of the hollow space 2. The converter 11 and the electronic control circuit 13 are here stationarily mounted on the B-side bearing shield 6 and do not rotate in unison with the hollow shaft 1. In the simplest case, the electronic control circuit 13 includes the drivers for switching the converter valves of the converter 11 on and off. In more complex embodiments, the electronic control circuit 13 may also include, for example, control circuits and protective electronic circuits for controlling and protecting the converter. The hollow shaft 1 is supported on the B-side on bearings 7 and on the A-side on bearings 14. The electric motor is enclosed on the B-side by an end shield 6 and on the A-side by an end shield 5.

The converter 11 can also be implemented as an inverter (DC-AC converter), a DC-link converter or a matrix converter. Because the converter 11 and more particularly the electronic control circuit 13 include complex, sensitive components, these must not rotate with the hollow shaft 1, as is possible with the simple rectifier disclosed in U.S. Pat. No. 5,424,593. Contrary to the teachings of U.S. Pat. No. 5,424,593, the converter 11 and the electronic control circuit 13, which in the U.S. Pat. No. 5,424,593 is not integrated in the hollow shaft, must be stationarily mounted inside the hollow shaft, to prevent destruction or premature wear of the converter and/or the electronic control circuit.

In the exemplary embodiment, the electronic control circuit 13 and the converter 11 are mounted on the bearing shield 6 of a common housing 15 by using screw connections 16. It will be understood that the electronic control circuit 13 and/or the converter 11 can also be mounted on other stationary components of the electric motor. Alternatively, for example, the electronic control circuit 13 and the converter 11 can also be stationarily mounted by way of a suitable superstructure or frame of the bearing shield 6.

For a particularly space-saving construction, a transducer, for example in the form of a position sensor, which is typically mounted on the shaft of the motor, can advantageously be mounted in the hollow shaft 1 of the electric motor. The signal track 9 of the transducer is hereby advantageously arranged on the inside of the hollow shaft, as shown in FIG. 1. The tracks are thereby advantageously protected against mechanical stress resulting from centrifugal forces; in addition, more signal-producing increments can be applied to the signal track due to the larger diameter of the hollow shaft compared to the diameter of the shaft on the A-side, which increases the transducer resolution. The rotating signal track 9 is measured by a stationary sensor 10 and evaluated by an electronic evaluation circuit 12 which is partially, or as depicted in the exemplary embodiment, completely integrated in the hollow space 2 inside the hollow shaft 1 and mounted stationarily. The transducer information (e.g., the position of the hollow shaft) is the transmitted, for example, to the electronic control circuit 13 or a supervisory control (not shown) located inside or outside the electric motor.

In the exemplary embodiment, the electronic control circuit 13, the converter 11 and the electronic evaluation circuit 12 are housed in a common housing 15 which is screwed to the B-side bearing shield 6. It will be understood that the electronic control circuit 13, the converter 11 and the electronic evaluation circuit 12 can also be integrated in separate housings or inside the hollow shaft 1 without any housing.

For cooling the electronic control circuit 13, the converter 11 and the electronic evaluation circuit 12, fan blades 8 are mounted on the inside of the hollow shaft 1 of the motor on the B-side of the electric motor. When the hollow shaft 1 begins to rotate, this simple design provides reliable forced cooling of the electronic control circuit, the converter 11 and the electronic evaluation circuit 12.

The term bearing shield in the context of the present invention is used synonymously with bearing shield cover.

The application of this type of electric motor is particularly advantageous in a drive system used with machine tools or production machines, because those machines require a compact space-saving design with a high integration density of the individual components

1.-10. (canceled)

11. An electric motor, comprising:
an internal rotor;
a hollow shaft connected to the rotor and having an interior hollow space; and
a power supply for supply of electric energy to the electric motor, said power supply including a converter, and an electronic control circuit operatively connected to the converter, said power supply being integrated entirely in the hollow space of the hollow shaft and stationarily mounted within the hollow space.

12. The electric motor of claim 11, further comprising a bearing shield for attachment of the converter.

13. The electric motor of claim 11, further comprising a transducer integrated in the hollow space within the hollow shaft.

14. The electric motor of claim 13, wherein the transducer has at least one signal track arranged on an inside surface of the hollow shaft.

15. The electric motor of claim 13, wherein the transducer is a magnetic transducer.

16. The electric motor of claim 13, wherein the transducer is an inductive transducer.

17. The electric motor of claim 13, wherein the transducer is an optical transducer.

18. The electric motor of claim 13, wherein the transducer is a capacitive transducer.

19. The electric motor of claim 13, wherein the transducer has an electronic evaluation circuit partially or completely integrated in the hollow space within the hollow shaft.

20. The electric motor of claim 11, further comprising fan blades attached to an inside surface of the hollow shaft.

21. The electric motor of claim 11, wherein the converter is implemented as a converter without an DC-link capacitor.

22. The electric motor of claim 11, wherein the converter is implemented as a matrix converter.

23. A machine-tool or production machine, comprising an electric motor including an internal rotor, a hollow shaft connected to the rotor and having an interior hollow space, and a power supply for supply of electric energy to the electric motor, said power supply including a converter, and an electronic control circuit operatively connected to the converter, said power supply being integrated entirely in the hollow space of the hollow shaft and stationarily mounted within the hollow space.

24. The machine tool or production machine of claim 23, further comprising a bearing shield for attachment of the converter.

25. The machine tool or production machine of claim 23, further comprising a transducer integrated in the hollow space within the hollow shaft.

26. The machine tool or production machine of claim 25, wherein the transducer has at least one signal track arranged on an inside surface of the hollow shaft.

27. The machine tool or production machine of claim 25, wherein the transducer is a magnetic transducer.

28. The machine tool or production machine of claim 25, wherein the transducer is an inductive transducer.

29. The machine tool or production machine of claim 25, wherein the transducer is an optical transducer.

30. The machine tool or production machine of claim 25, wherein the transducer is a capacitive transducer.

31. The machine tool or production machine of claim 25, wherein the transducer has an electronic evaluation circuit partially or completely integrated in the hollow space within the hollow shaft.

32. The machine tool or production machine of claim 23, further comprising fan blades attached to an inside surface of the hollow shaft.

33. The machine tool or production machine of claim 23, wherein the converter is implemented as a converter without an DC-link capacitor.

34. The machine tool or production machine of claim 23, wherein the converter is implemented as a matrix converter.
